(19) United States
(12) Patent Application Publication
(10) Pub. No.: US 2006/0277176 A1
(43) Pub. Date: Dec. 7, 2006

(54) System, method and apparatus of constructing user knowledge base for the purpose of creating an electronic marketplace over a public network

(75) Inventor: Ju Wu Liao, New York City, NY (US)

Correspondence Address: Ju W. Liao, 1010 Hylan Blvd., New York City, NY, 10305, US

(73) Assignee: Mydrew Inc., Dover, DE (US)

(21) Appl. No.: 11/438,457

(22) Filed: May 23, 2006

Related U.S. Application Data
(60) Provisional application No. 60/685,787, filed on Jun. 1, 2005.

(51) Int. Cl. G06F 17/30

(52) U.S. Cl. 707/5

(57) ABSTRACT

System and method of constructing entity knowledge base for a user entity creating an electronic marketplace for that entity. Entities can add entity data of one or more direct or indirect entities to their knowledge base. The entity knowledge base created provides a specific marketplace for any primary entity by allowing access to the restricted and unrestricted data associated with entities contained in the knowledge base of that primary entity. The system creates a general marketplace for any primary entity by allowing access to unrestricted data associated with all user entities in the system. Furthermore, each entity will contain confidence levels whereby these modifiable levels will determine the amount of access to data provided to associated entities included in a entity's knowledge base. The system will include methods to restrict access to knowledge bases of associated entities based on data contained in a primary-user entity.

### BACKGROUND OF THE INVENTION

1. Field of the Invention

The present invention relates to the management of data for the purpose of providing an electronic marketplace for users and market participants. Specifically the invention relates to a system, method and apparatus of constructing a user knowledge base, where by construction of such base can provide a general marketplace or entity specific marketplace for the business of facilitating electronic commerce.

2. Description of the Background Art

Since the inception of computers, markets have evolved from being a physical place of commerce to an online virtual place of e-commerce. Before the Internet, people would have to physically be present at a common location in order to research, inspect, buy, sell or trade goods and services. Now that the Internet is ubiquitous, the same market participants can simply go online to perform these traditional market activities. The emergence of online markets has created vast efficiencies in the way people perform commerce resulting in numerous benefits to consumers, producers and sellers alike.

For example, a consumer who is in the process of purchasing a new washing machine does not need to visit an appliance store in order to research, compare and purchase the appliance. The consumer can now do his or her research online, make comparisons online and even purchase the washing machine online; essentially becoming a more efficient consumer. Producers can display, market and sell their products online in a virtual storefront, eliminating the need for commercial storefront, in addition to reducing the overhead associated with maintaining such physical sales channels.

As online markets mature, the advantages and efficiencies of an online electronic marketplace will be readily apparent. Internet markets will exist not only for the benefit of large corporations but also for the benefit of small businesses and individuals as well. Online markets will reach peak efficiency when every market participant is capable of transacting online in a custom market made specifically for each and every market participant.

(Disadvantages of the Current Method)

Online markets have become the popular alternative to offline venues such as newspapers, shopping malls, flea markets, barter groups and small businesses. Online markets has spawned several business models in hopes of achieving the goal of total market efficiency. Such models include online classifieds, online auctions and online bulletin boards. Each of these business models has their unique advantages and disadvantages. All models do achieve a level of efficiency that has allowed them to sustain growth and become an alternative market to their offline counterparts. However the main disadvantage that all markets have, is that the amount of confidence market participants have in performing a transaction, would be directly proportional to the credibility of the market participants involved in the transaction.

Print advertisements provide an excellent outlet for reaching prospective buyers. However, print advertisements such as newspapers are essentially a seller driven marketplace where sellers are limited to the number of readership of a particular newspaper. The method of newspaper classifieds would be for a seller to place an advertisement which would contain seller contact information, to be used by buyers in order to complete a sale. The disadvantage of print advertisements is that both parties may not have had previous contact with each other until the start of a current transaction. Credibility of the parties involved, would be determined after initial contact, and depending on the level of mutual confidence that is available, the transaction may or may not warrant completion.

The advent of the Internet has created new online virtual markets. Markets where an individual can buy, sell and trade from any location given there is an internet connection and a computer connected to the internet. Internet technology has created virtual markets based on auctions, bulletin boards, classifieds and virtual storefronts. The disadvantage of these models is obvious as online commerce is inheritantly impersonal. It is difficult if not impossible to distinguish market participants due to the anonymity of the technology. Therefore unless market participants already have an established reputation, it proves to be difficult to establish mutual credibility had there not been an existing previous relationship.

Online auctions have proven to be a very popular venue for online exchange. Auctions are seller driven marketplaces where buyers can bid against each other on a specific item usually in a finite period of time. Limitations of auctions are that bidding of an item must take place in a fixed time period. Fixed periods are necessary in order to close biddings and complete a transaction, howver because auctions must occur over a fixed period of time, gathering the optimal audience to bid on items will not always occur. An auction is only as effective as the number of buyers who are bidding on the goods. Again, issues of mutual credibility arise in online auctions as participants must determine the reliability of entering into a transaction, where the reputation of a seller is not readily apparent.

Electronic bulletin boards consist of a conglomerate of postings or advertisements, usually aggregated based on subject, location, title or other user defined category. Bulletin boards provide an individual the ability to place advertisements for an item which can be viewed by all users who read or subscribe to that specific bulletin. Online bulletin boards lack rules and processes in which transactions must take place, resulting in transactions that may be unstructured. The effect of this unstructuredness is that reliability as well as credibility become more difficult to achieve. The normal process of a bulletin board would be for a buyer to contact a seller using an alternative method such as electronic mail, telephone or fax in order to inquire or complete a transaction. Buyers must be knowledgeable about the purchase or subscribe to a specific bulletin board in order to discover items that are of interest or value. The number of bulletin boards has greatly increased, making it difficult for sellers to broadcast and locate their optimal target audience.

Virtual stores is a venue that allows small businesses as well as large corporations to sell items to the online masses. The process of buying and selling in an online store mimics that of physical store, in that items are first displayed by the seller, buyers can then add items to a virtual shopping cart and check out when they are ready to pay; all as if they were inside a physical store. Sellers who utilize virtual stores are normally repeat sellers who carry a large amount of inventory. One time sellers who may have a need to only sell an item once may not utilize an online store because the amount of resource needed to create such a venue would not warrant the return on a single sale. In order for the seller to create credibility with their customers using an online storefront, much resources would be needed in generating goodwill. Unless the online store was an extension of an already credible retail business, the disadvantages of mutual credibility would be a major issue.

Online classifieds like their physical counterpart provide an excellent outlet to reach prospective buyers. Online classifieds provide a single virtual location where sellers can post an advertisement amongst a multitude of categories. The method used to complete a transaction would be for a buyer to contact a seller using the contact information provided by the seller. In most cases the participants of a transaction usually have no previous dealings with one another until the current transaction. It is only until after a completed transaction where both parties are satisfied does the disadvantage of mutual credibility diminish. Even after a successful transaction, the likelihood that either party would again engage one another in another separate transaction, would be low using this model of commerce.

Flea markets, shopping malls and retail stores are excellent venues to buy and sell goods or services. The major limitation of venues such as these would be that a person would need to physically be present in the geographic area where the market, mall or store is located in order to utilize or patronize its services. Other limitations include hours of operation of the venue, proximity of the venue to the area of residence, logistics in transportation to the venue, shipping and handling of purchased items, and a finite number of stores and businesses accessible to any specific individual. A disadvantage of public venues is that goods and services that are sold are not personalized to the individual customer. In order for any one person to be able to find items that would be of interest to him or her, he or she would also need to review items that may or may not be of any interest to them. This concept of overselling an individual, in terms of providing items inclusive to the items that are needed for a single person, in the effort to satisfy other customers, proves to be costly in terms of effiency for any single customer.

In any given marketplace whether online or offline, there needs to be an expected level of mutual credibility between the buyer and seller in order for a transaction to take place. The seller of goods and services must be assured that he or she will receive the proper amount of payment for the sale, on the other hand the buyer of those goods and service must be assured that the item that they are purchasing is at a quality and reliability that they expect given the amount of money that they are willing to spend. Depending on the market environment, mutual credibility can be easier established in certain markets that in others, however no market can guarantee their market participants total reliability or credibility. There will always exist a certain amount of manageable risk whenever entering into a transaction.

In order for markets, online or offline, to effectively satisfy the needs of their participants, they would need to be more efficient. For example, a person seeking to buy a television would not visit a vegetable market. Now if that same person were to visit an electronics store, he or she would be presented with a variety of electronics from radios, to DVD players, to televisions. The store may present these trivial goods to a television buyer because they are obliged to present the broadest amount of goods to their customer base in order to satisfy the greatest number of potential customers; although this method presents an efficiency problem to the person just looking to buy a simple television set. Inefficiencies are clear when a person walks into the television department and is presented with big screen televisions, high definition televisions, plasma televisions, projection televisions in addition to myriad of televisions of all size, shapes and features. The amount of ineffiency such a market presents is readily apparent when we realize that what the customer had already decided on was a simple 13 inch color television.

Markets, due to their inclusive nature are not personalized or catered to a single participant but rather to multiple participants. It would be unrealistic, if not impossible to create a dedicated market for a single individual at any point in time. For example, if a market were to know that a customer would be visiting the market for the sole purpose of purchasing a 13 inch color television of a specific brand, that market would have readily available that specific television and that television only, for display, when this potential customer arrives at that specific time. This scenario would be highly unlikely as it entails predicting the future behavior as well as preferences of that single customer and at the same time for all other customers who participate in that market.

Markets can be more efficient by being able to reduce the amount of products displayed for any given market participant. Not unsimilar to our imaginary ultra efficient market, these realistic markets must be able to predict with an expected amount of certainty the preferences and behaviors of our market participants and make available for display the greatest number of goods which satisfy these participants with an expected amount of certainty. Predictions of future behavior of a market participant can be associated to some degree on past behaviors of that participant. Future preferences of a particular market participant can be correlated with the preferences of the immediate relationships of that participant. Efficient markets can essentially be created by leveraging the relationships of a market participant, where those relationships are with other participants, in order to form a behavioral and preferential map of any particular participant, such that the map for each participant is intertwined to form a reliable historical snapshot of preference and behavior for any given market participant at any period of time.

There exists a need for a more efficient online marketplace. Current markets can not survive unless inefficiencies exists such as, providing for and satisfying simultaneously the greatest number of market participants at any given moment in time. It is only in this sense can a market develop the necessary size to be sustainable and compete, however at a cost to the market, which can be measured in its inefficiencies. Marketplaces of the future, in order to be more efficient, will begin to utilize historical data of direct and indirect relationships of a market participant, in order to generate a behavioral and preferential map of that market participant. By generating an interconnected map of market participants, a marketplace is able to personalize a market to individual participants and be able to reach a level of efficiency that is unattainable using the present methods of markets today.

### SUMMARY OF THE INVENTION

The present invention consists of a system, methods, rules and apparatus for providing an electronic marketplace through construction of user knowledge base in creating an efficient electronic marketplace.

The said invention encompasses interfaces to provide a central virtual location where a user who has an internet connection and a computer to access the said internet connection, the ability to add or remove entity knowledge to the said user's knowledge base, the ability to place statuses on individual entity or multiple entities for the purpose of restricting the access to associated entity data, the ability to display entity data created from a said user's knowledge base, the ability to send electronic messages for the purpose of creating a knowledge base.

The methods comprise of constructing and maintaining a central database, where the said database contains entity data associated with a user. Users are assigned a unique user identification number, in which the said user identification number is associated with entity data for that said user, the entity data itself will also contain a unique identifier, in which the said entity is to be saved to a database for the associated user. Users can delete entity data associated with their user identification and entity identification, from the said database.

According to an aspect of the invention, the methods comprise of constructing associated user entity data for a primary user in the system for purposes of constructing a knowledge base. A primary user will be able to send electronic messages through a mail gateway to a secondary user. Electronic messages can be sent in single or multiple instances where each electronic message has a unique destination. Users who receive the said electronic message can acknowledge the electronic message resulting in the registration of the recpient user entity to the primary user of the message. Registration includes saving into database entity data associated with the said users.

According to an aspect of the invention, the methods comprise of constructing a user knowledge base for a primary user upon authentication of the said user by the system. An initial search will begin from the central database for all associated entities containing the user identification of the said authenticated user. Consecutive searches from the central database will commence returning the entities which contain the unique entity identifier of the previous search, where the resulting searches will end given there is no more than six searches for any single authenticated user. Results from the search will be saved into computer memory, whereby the saved entity data is now the user knowledge base for that authenticated user.

According to an aspect of the invention, the methods comprise of searching a central database for data associated with user entities satisfying one or more criteria. Results of the initial search will be matched to the unique entity identification field of each particular user entity in a said user knowledge base. Data that matches the entity identification field will be displayed to the said primary user for inclusion in the said primary user personal market environment.

According to an aspect of the invention, the methods comprise of searching a central database for data associated with user entities satisfying-one or more criteria. Results of the initial search will be displayed to the said user for inclusion in the said user's personal market environment in the case where the said user's knowledge base does not contain any entity data.

According to an aspect of the invention, the methods comprise of searching a central database for data associated with a said user's knowledge base. The resulting search may return an undetermined number of matches based on the said user's knowledge base, depending on the requested confidence level specified by the user, whereby the confidence level is representative of the number of consecutive recurring searches from a central database in creating a users knowledge base.

According to an aspect of the invention, the methods comprise of setting a primary confidence level for a user in which the confidence level determines the number of consecutive recurring searches from a central database in creating the said user knowledge base. The primary confidence level and unique user identifier will be saved to a central database.

According to an aspect of the invention, the methods comprise of setting a secondary confidence level for a user in which the said secondary confidence level determines the amount of restrictive access for associated data of the said user. The secondary confidence level and unique user identifier will be saved to a central database.

According to an aspect of the invention, the methods comprise of setting and assigning primary and secondary status flags to entities associated with a primary user. The assigned primary status will restrict the amount of access for the primary user to the associated data of associated restricted user entities. The assigned secondary status will restrict the amount of access for all associated user entities to the data of the said primary entity.

### BRIEF DESCRIPTIONS OF THE DRAWINGS

FIG. 1. High Level Overview of System Architecture

FIG. 2. Detailed View of Knowledge Base Architecture

FIG. 3. Flow Chart for Adding to User Knowledge Base

FIG. 4. Flow Chart for Remove from User Knowledge Base

FIG. 5. Detailed View of User Knowledge Base Manager

FIG. 6. Flow Chart for Building User Knowledge Base

FIG. 7a. Flow Chart for Browse General Entities

FIG. 7b. Flow Chart for Browse User Entity Listings

FIG. 8. Flow Chart for Display User Knowledge Base

FIG. 9. Flow Chart for Setting Primary Confidence Level

FIG. 10. Flow Chart for Setting Secondary Confidence Level

FIG. 11. Flow Chart for Setting Primary Status Flag

FIG. 12. Flow Chart for Setting Secondary Status Flag

FIG. 13. Flow Chart for Sending Knowledge Base Invitations

FIG. 14. Flow Chart for Confirming Invitations

FIG. 15. Flow Chart for Creating User Entity Profile

FIG. 16. User Interface for Knowledge Base Display

FIG. 17. User Interface for Setting User Entity Flags

FIG. 18. User Interface for Setting Confidence Levels

FIG. 19. User Interface for Browse General Entities

FIG. 20. User Interface for Sending Knowledge Base Invitations

FIG. 21. User Interface for Creating User Entity Profile

### DETAILED DESCRIPTIONS OF THE PREFERRED EMBODIMENTS

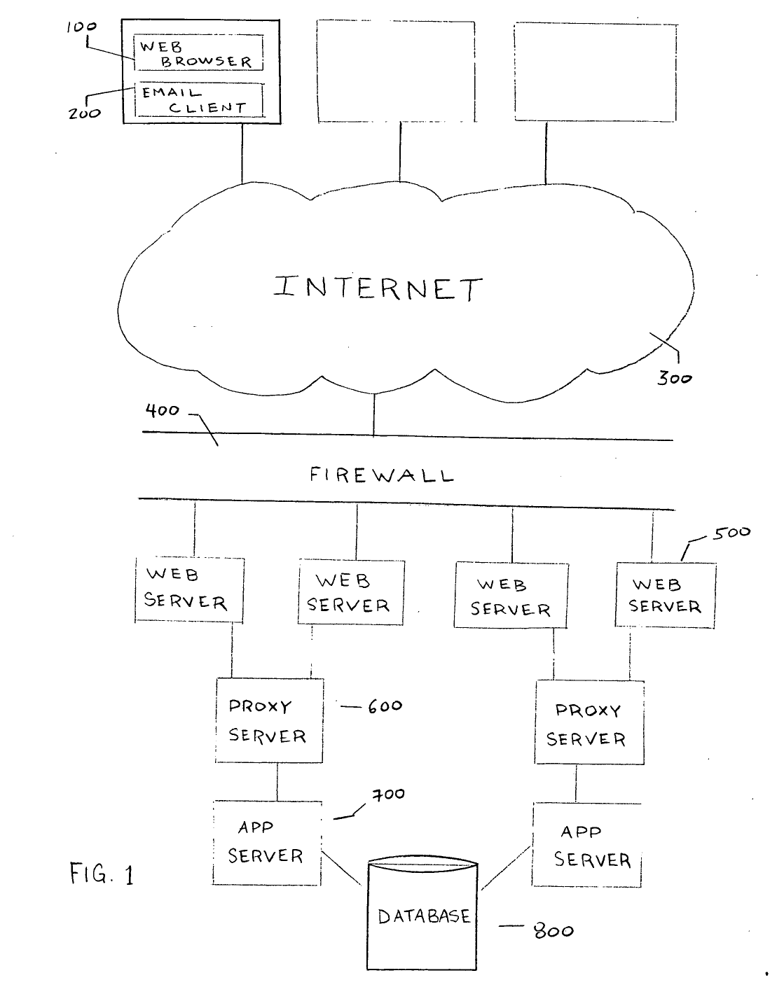

FIG. 1. details the overall architecture of the system. This invention provides one or more users, regardless of location the ability to transact over the internet using currency or goods and services as a payment method. [100] Users who are participants in this market will access the invention with a computer, in which the said computer contains internet browser software. The user must have a connection to the internet. the said connection can be a dial-up, DSL, broadband, ISDN, T1, T2, T3 or OC connection. Users who access the system through the [300] internet will use the TCP/IP protocol as the protocol for internet communications. Other higher level protocols such as HTTP, HTTPS and FTP can also be used in order to utilize the system. Access to the system will be restricted by a [400] hardware firewall, where the said firewall shall be configured to allow all acceptable traffic to pass through while at the same time restricting all deniable traffic from entering. All incoming request will be processed by the [500] web server software which will reside behind the hardware firewall. Web server software can be configured as multiple instances, providing a level of fault tolerance and load balancing. There will exist a [600] proxy software layer that communicates and processes incoming requests from the web server layer. The proxy server software will determine the type of application service needed to process a request originating from the web server. Proxy software will direct the request to the proper application component in the next software layer, [700] the application server software. The application server software will provide all transaction processing for the incoming requests. The application software has access to a [800] database software where data can be saved for later retrieval and processing. Request from user containing sensitive information such as passwords, financial data and customer information will be transmitted securely using the SSL protocol using 128 bit public key encryption.

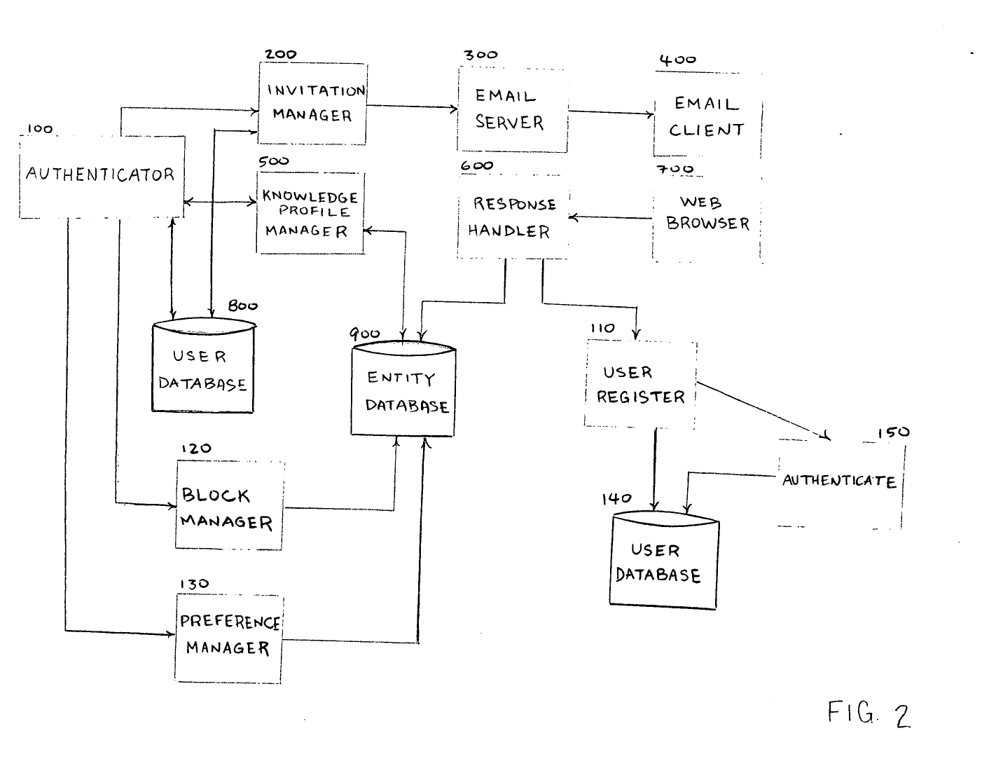

FIG. 2. details the overall architecture of the knowledge base system. The process begins with the sign in of a registered user. A registered user is represented as a person who has information associated with a unique user identifier saved in the central database. [100] The said user will be prompted for a username and password whereby a search of the central database will authenticate the username and password pair, retrieve user entity data and save such data to memory. Once the said user is authenticated, [500] a knowledge profile will be generated for the said authenticated user. A primary confidence level will be retrieved from the user [900] entity data, whereby such primary confidence level represents the degree to which the said user knowledge base will be generated. A search of the entity database will begin for entities associated with the authenticated user. The resulting entities returned from the search will be saved to memory so that these said entities returned will be associated by a unique entity identifier and the user identifier of the authenticated user. The search count will be compared to the primary confidence level, in so that if the search count has not yet exceeded the primary confidence level, another search of the entity database will begin, in so that the search for entities will contain the unique identifiers of the resulting entities of the previous search as the criteria. Again results from the entity database search will be saved to memory and contain a unique entity and user identifier combination. Again, searches of the entity database will continue using the unique entity identifier of the last returned entities as the criteria, however in the event that the primary confidence level exceeds the number of performed searches, the searching of the entity database will end and the user knowledge base associated with the said authenticated user will be complete.

FIG. 2. also details the process of the invitation controller. The process begins when a [100] authenticated user initiates the addition of entity data into the said user's knowledge base. [200] A interface will be provided to allow the user to enter in the email addresses or a unique user identifier of one or more potential associated user entity. [300] An electronic message will be sent through a mail server, in which the invited user can view using a [400] email client. [700] The sent electronic message will contain a link or uniform resource locator that will allow the recipient to confirm the invite and be added to the said authenticated user's entity database. [600] A response handler will search a user database with the email address or unique user identifier as criteria. If the recipient is not found in the user database, the recipient will be requested to register into the system [110]. Upon confirmation of registration [150], the registered recipient will then be added to the entity database associated with the said authenticated user [140].

FIG. 2. also details the process of the entity flag controller. The process begins where an authenticated user [100] begins a search on an entity contained in the said user's knowledge base [800]. The entity database will be searched based on the unique identifier of the user and the unique entity identifier of the said entity. The data associated with the said entity will be displayed to the user. [120] A user flag can be set on the user entity at this time, where by the entity database will be updated [900]. The knowledge base of the user will be updated to reflect the added flag status of the user entity [500]. A entity flag can also be applied on the user entity in addition to all associated entities of the said flagged user entity, also resulting in the entity database being updated. The knowledge base of the user will also be updated to reflect the added flagged status of the associated entities.

FIG. 2. also details the process of the preference controller [130]. The process begins where an authenticated user selects a primary preference [100] or primary confidence level. Primary preference will determine the scope of the user knowledge base to be used when displaying and creating the associated entities of user entities contained in the knowledge base of that authenticated user. The user entity data will be updated to reflect the selected primary preference and saved to the user database [800]. The authenticated user can also select a secondary preference or secondary confidence level. The secondary preference will determine the access permitted to other entities accessing the authenticated user's associated entities. The user entity data will be updated to reflect the selected secondary preference and saved to the user database [800]. The secondary preference will be updated for all associated entities of the authenticated user, updates will occur to entities contained in the entity database [900].

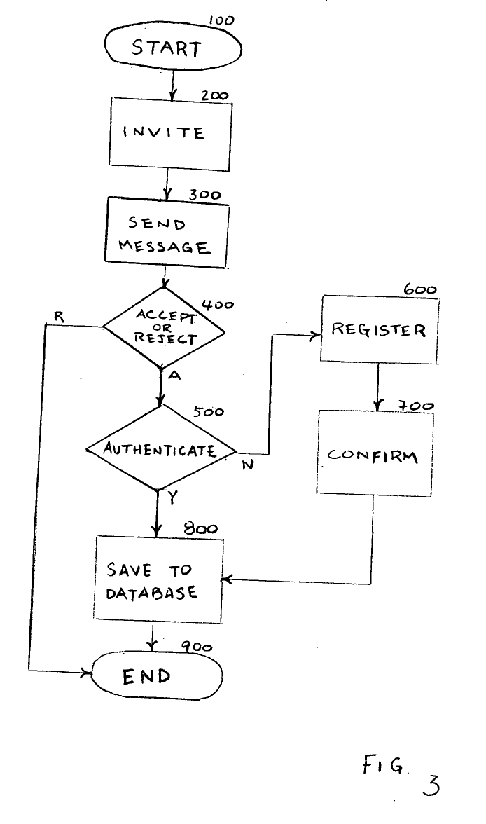

FIG. 3. details the process of adding a secondary user entity to a primary user knowledge base. The process begins with the [100] primary user entering the email address or unique user identifier into the [200] invitation interface. [300] Electronic messages will be sent to the email address in the user database had there been a email address entered or unique user identifier entered; a search for the email address of the user identifier in the user database will occur. There can be one or more email addresses as well as unique user identifier entered through the interface. Electronic messages can be read using an email client. [400] In the body of the electronic message, will be a link or uniform resource locator where the recipient can click on to confirm the invitation and be added to the knowledge base of the primary or sending user. [500] If the recipient already exists in the user database, then the recipient must authenticate in order to confirm the invitation. If the recipient does not already exist in the user database, [600] then the recipient will be displayed a registration page in which the recipient can register. [700] Upon confirmation of registration by the recipient, the now registered recipient will be added to the primary user knowledge base [800].

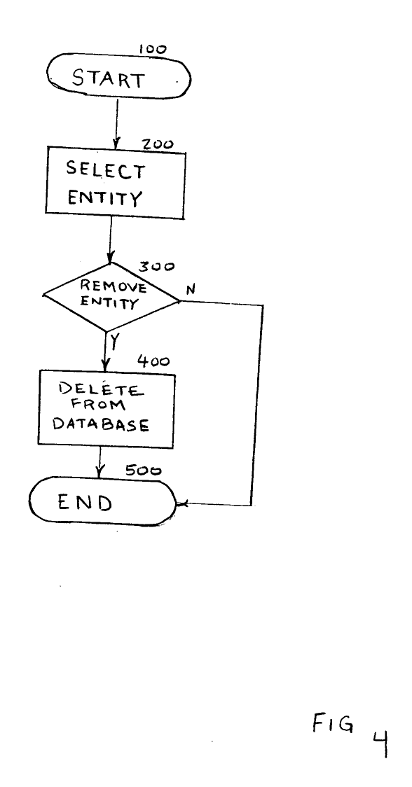

FIG. 4. details the process of removing a secondary user entity from a primary user knowledge base. [100] The process begins with all directly associated user entities contained in a primary user knowledge base to be displayed through a user interface. [200] The user entity that is to be removed is selected. [300] The selected user entity is then deleted from the primary user knowledge base. [400] The network database is updated to remove the record associating the primary user entity with the removed user entity.

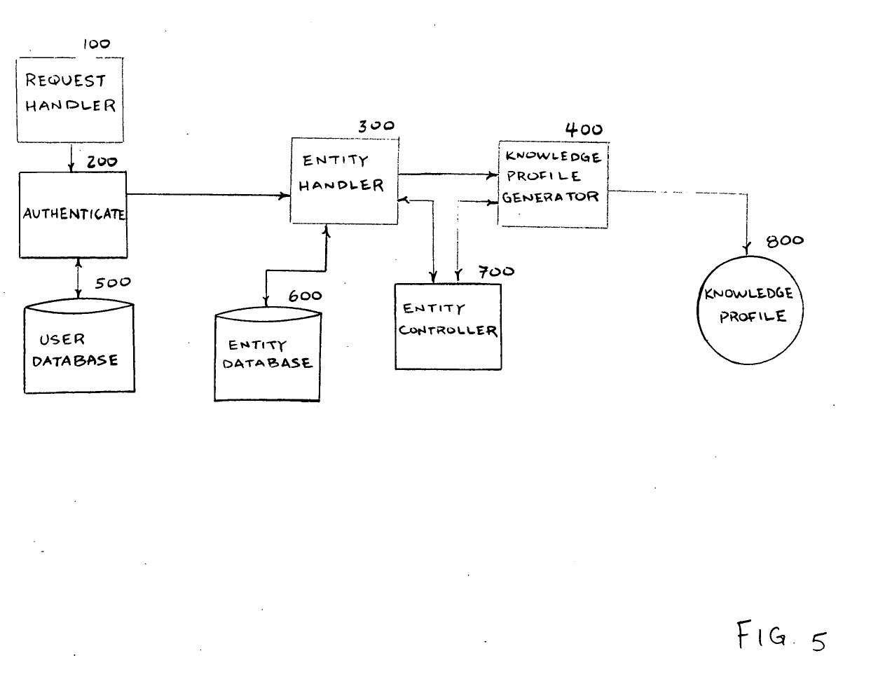

FIG. 5. details the high level overview of the knowledge base controller. [100] A user begins by entering a user name and password using a web interface. [200] A web server will process the form through the request handler. [500] Once authenticated the knowledge base controller will begin the process of creating a knowledge base for the authenticated user. The knowledge base controller consists of an entity request handler [300] which is responsible for searching the entity database [600], an entity controller [700] which processes all entities associated with an authenticated user and the knowledge profile generator [400], which manages and creates the user knowledge base [800] using memory associated with an authenticated user.

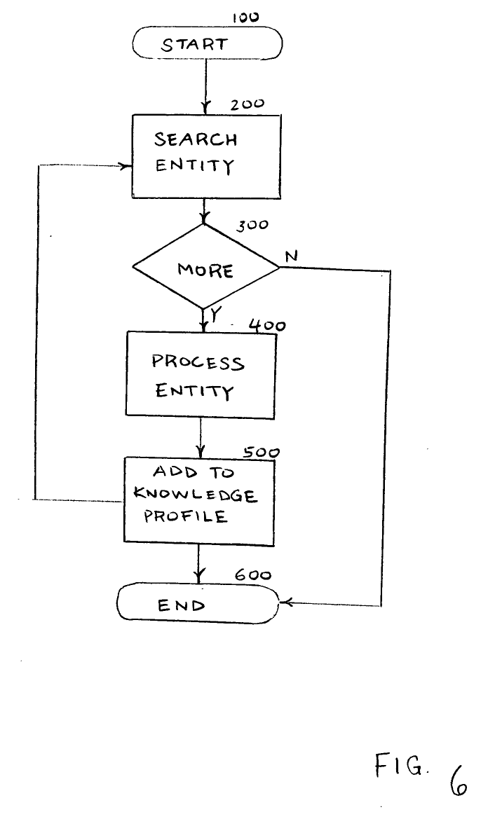

FIG. 6. details the process of creating a user knowledge base for an authenticated user. [100] The process begins with authenticating a user by validating a unique user identifier and a password, by searching the user database. If the resulting pair results in a match, the user is then considered authenticated. The entity database is searched using the authenticated user identifier as a primary qualifier.

The results will return all directly associated user entities of that said authenticated user. [300] The entities resulting from the search will be passed to the profile generator, where the primary confidence level of the authenticated user is retrieved. If the primary confidence level equals 0 then no knowledge base will be generated. Any primary confidence level above 0 will indicate the number of searches to be performed in creating the knowledge base of the authenticated user. If the number of searches does not exceed the primary confidence level, the entity database will be searched again for associated user entities using the unique user entity identifier contained in the results of the previous search as the qualifier. [400] The search of the entity database will end when the number of searches performed exceeds the primary confidence level of the primary authenticated user. [500] The results of all the searches to the entity database will be saved to memory, where it will be referred to as the user knowledge base and be associated with a unique identifier of the authenticated user.

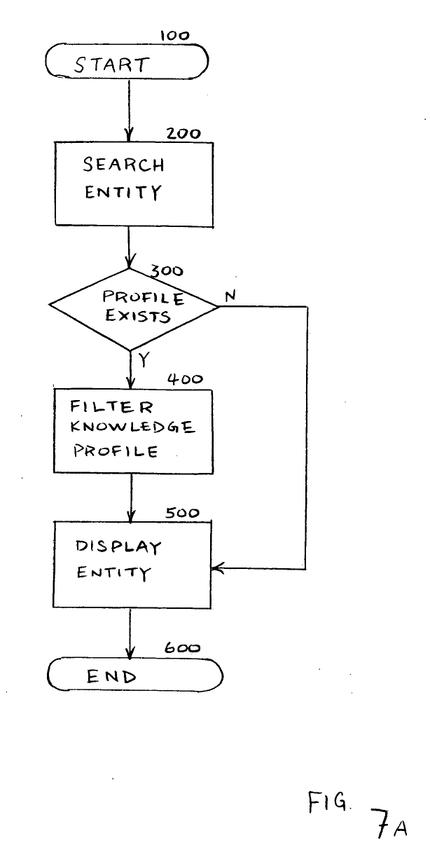

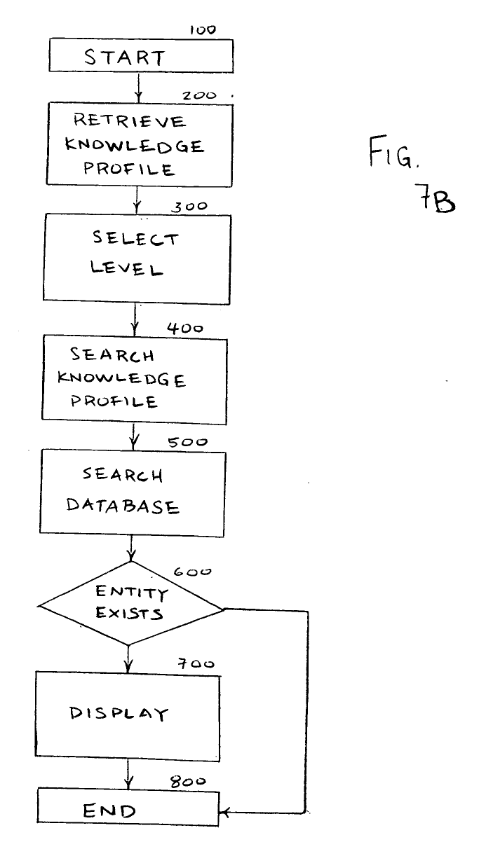

FIG. 7A. details the process of displaying associated entity data of all entities with respect to an authenticated user knowledge base [100]. The process begins with a search of the entity database for entities using one or more entity criteria [200]. The results from the search [300] will be filtered in order to remove non matching entities, where matches will be determined by the data contained in the authenticated user knowledge base. [400] If there does not exist a knowledge base for the authenticated user or if the primary confidence level of the authenticated user entity is equal to zero, then filtering will not occur and all said resulting entities will be displayed through the user interface. If the confidence level of the authenticated user entity is between 1 and 6, then the said resulting entities will be compared individually to each associated entity in the authenticated user knowledge base. The comparison will be based on the unique entity identifier of both the entity contained in the resulting search and the entity contained in the said user knowledge base. If unique identifiers are matched and the status on the knowledge base entity is not flagged, then the matched entity will be saved to memory. [500] Once all entities are compared and matched, the resulting saved entities will be displayed through a user interface for the authenticated user.

FIG. 7B. details the process of displaying associated entity data of all entities with respect to a selected level pertaining to the depth of associated entities retrieved from an authenticated user knowledge base. [200] The process begins with creating of a user knowledge base for the authenticated user based upon a pre selected primary confidence level [300], in which the selected primary confidence level will determine the number of searches performed on the entity database in which resulting associated entities retrieved will be based on the unique identifier from the results of the previously searched entities [400]. The entity database will be searched [500], where the results from this search will be compared individually to each user entity in the said authenticated user knowledge base. The comparison will be based on the unique entity identifier of both the entity contained in the resulting search and the entity contained in the said user knowledge base. [600] If unique identifiers are matched and the status on the knowledge base entity is not flagged, then the matched entity will be saved to memory. [700] Once all entities are compared and matched, the resulting saved entities will be displayed through a user interface for the authenticated user.

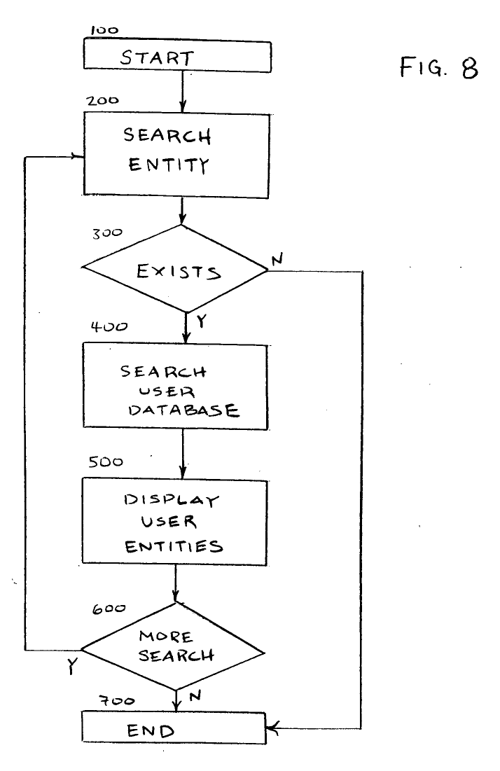

FIG. 8 details the process of displaying associated user entity data of entities contained in the knowledge base of an authenticated user [100]. The process begins by searching the the entity database [200], where the initial search will use the unique user identifier of the said authenticated user as a criteria. [300] The resulting entities returned from the search will be used for a search to the user database, where the unique user identifier of the resulting entity database search, are used as the criteria for the search of the user database [400]. Results from the user database search will be displayed through a web interface for the authenticated user [500]. Displayed user entities can be selected [600], where the unique user identifier of the selected user entity is to be used as the primary criteria for a future search of the entity and user databases. The resulting search of user entities will be made available for future searches, unless the number of searches exceeds 6 or the result of the search do not return any additional user or entity data.

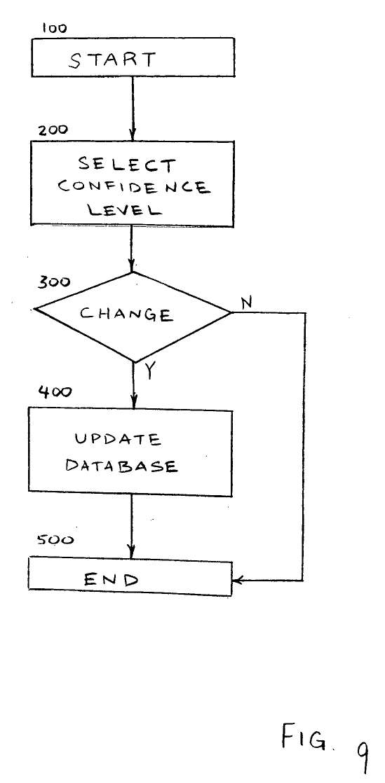

FIG. 9 details the process for resetting the primary confidence level for a user entity, in which such primary confidence level having the values between 0 and 6, determines the number of searches performed on the entity database in creating the knowledge base of the authenticated user [100]. The primary confidence level determines the degree to which associated entities pertaining to user entities with respect to the knowledge base, will be displayed on the user interface for the said authenticated user. [200] The process begins by the authenticated user selecting a primary confidence level. [300] The selected primary confidence level is compared to the existing primary confidence level retrieved from the authenticated user entity. If the selected primary confidence level is different from the retrieved primary confidence level, [400] then the primary confidence level for the authenticated user entity will be updated.

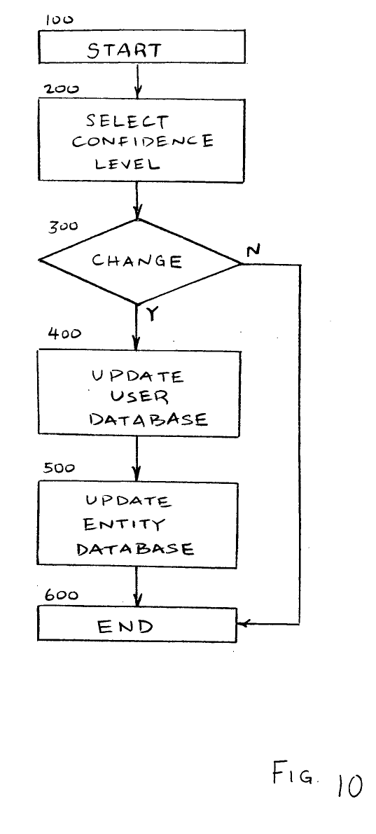

FIG. 10 details the process for resetting the secondary confidence level for a user entity [100], in which such secondary confidence level having the values between 0 and 6, determines the access permitted associated user entities to the entities that of the said authenticated user, whereby associated user entities whose knowledge base creation must include the said authenticated user entity in searching of the entity database, where the number of searches performed must be no greater than the secondary confidence level of the authenticated user. [200] The process begins by the authenticated user selecting a secondary confidence level. [300] The selected level is compared to the existing secondary confidence level retrieved from the authenticated user entity. If the selected secondary confidence level is different from retrieved secondary confidence level, [400] then the secondary confidence level for the authenticated user entity will be updated.

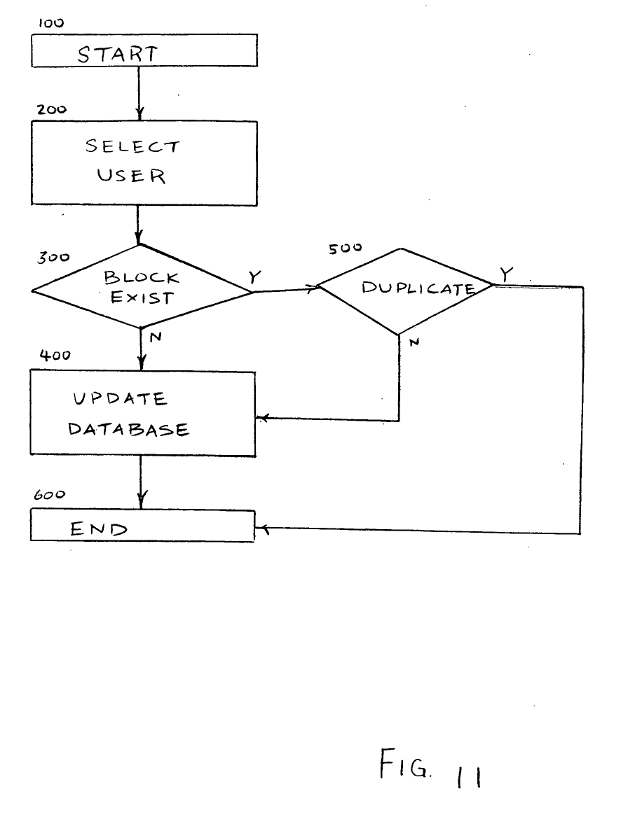

FIG. 11 details the process for preventing a single user entity from accessing associated entities of the authenticated user entity by setting a flag included in the user entity data [100]. The process also prevents the authenticated user entity from accessing data of any associated entities of the previously flagged entity. [200] The process begins by the authenticated user selecting a user entity for flagging, where by the flag to be set can include only the selected user entity.

If there does not exist a matching flag in the entity database for that selected entity, the entity database will be updated to reflect the new flagged value [400], else existing flags will be updated only if flags are not of the same value [500]. User entities containing a flag will not be included in the creation of user knowledge base for the flagging user.

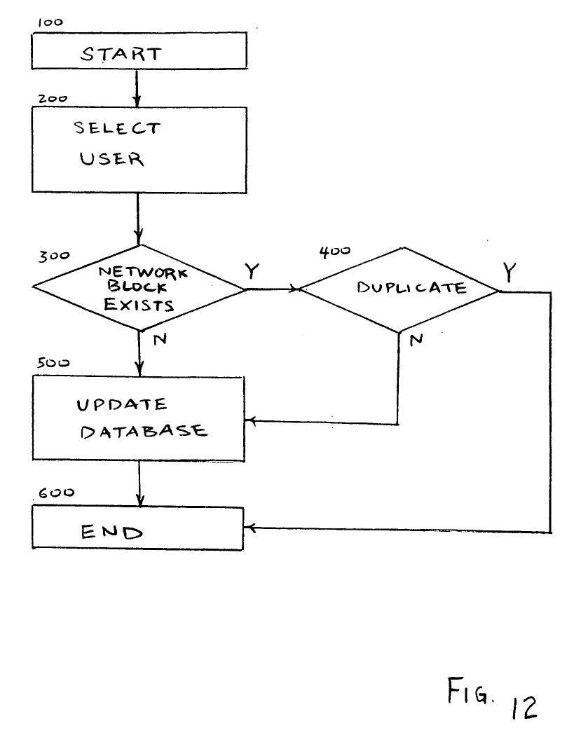

FIG. 12 details the process for preventing multiple user entities from accessing associated entities of the authenticated user entity [100] by setting a flag included in the user entity data. The process also prevents the authenticated user entity from accessing any data of associated entities of the previously flagged entities. [200] The process begins by the authenticated user selecting a user entity for flagging, where by the flag to be set can include all associated entities of that selected user entity. [300] If there does not exist a matching flag in the entity database for that selected entity, the entity database will be updated to reflect the new flagged value [500], else existing flags will be updated only if flags are not of the same value [400]. The selected flagged user entity and associated entities of the said flagged entity will not be included in the creation of user knowledge base for the flagging user.

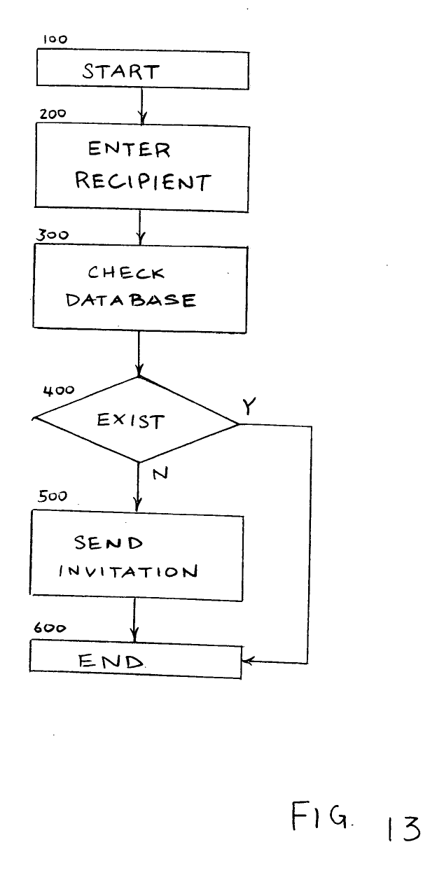

FIG. 13. details the process for sending electronic messages to potential user entities to be added to the authenticated user entity knowledge base. The process begins by an authenticated user [100] inputting one or more email addresses or unique user identifiers into a web interface [200], whereby the web interface will send such form data to an invitation handler. The invitation handler will perform a search on the user database [300] for each inputted email address or unique user identifier for a matching record [400]. Electronic messages will be sent to all email addresses entered through the web form as well as to all matched user identifiers resulting from a user database search [500]. Electronic messages will contain a link or uniform resource locator in which the recipient can click on the link or uniform resource locator to confirm the receipt of the message and have their user entity added to the knowledge base for the sender of the electronic message.

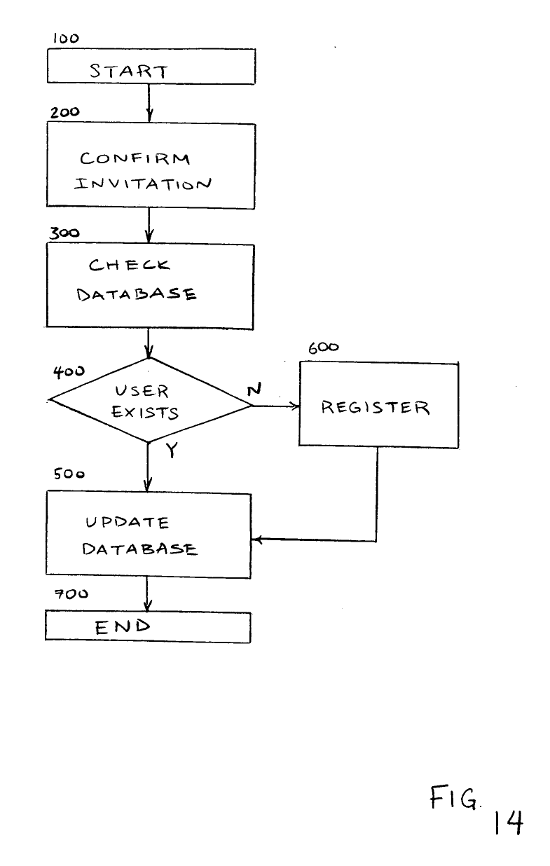

FIG. 14. details the process for recipients of electronic messages to confirm the addition of the recipient's user entity to the knowledge base of the sender of a electronic invitation message. [200] The process begins by the recipient clicking on the uniform resource locator in the body of the electronic message. [300] A search of the user database will occur using the recipient's email address or the recipient's unique user identifier as the criteria. [400] If there is a match resulting in a search of the user database, the recipient's user entity is automatically added to the user knowledge base of the sending user. If there are no matches for the recipient in the user database, [600] the recipient will be prompted to register with the system, where registration entails entering user information and selecting a unique user identifier. Upon completion of registration, the recipient will automatically be added to the user knowledge base of the sending user [500] and the data will be saved to the entity database.

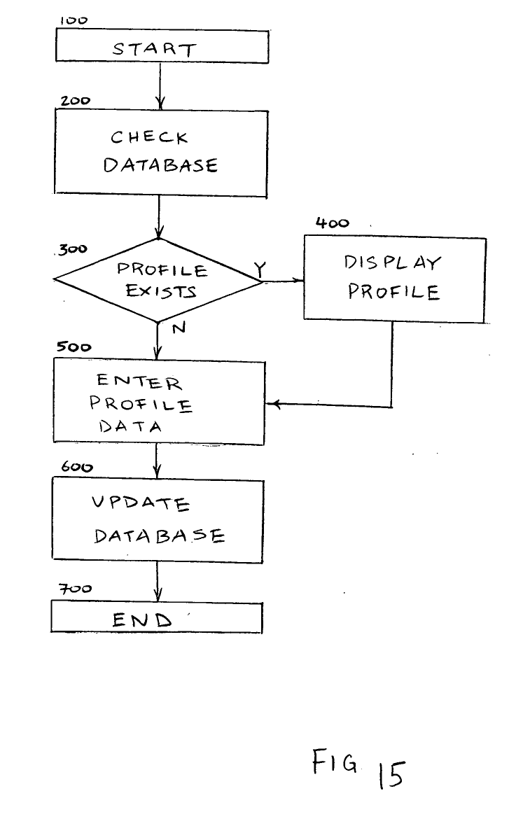

FIG. 15 details the process for an authenticated user [100] to update [200] user entity data where the [300] data being updated, contains description [400] of the said authenticated user. [500] The process begins with the said user entering data into fields existing in a web form. The said user can submit the form in which the user database will be updated [600] to reflect the new values entered. All descriptive data updated to the user database may be restrictive or non restrictive and can be accessed by a second user entity depending on the primary and secondary confidence level located in both the authenticated user entity and secondary user entity.

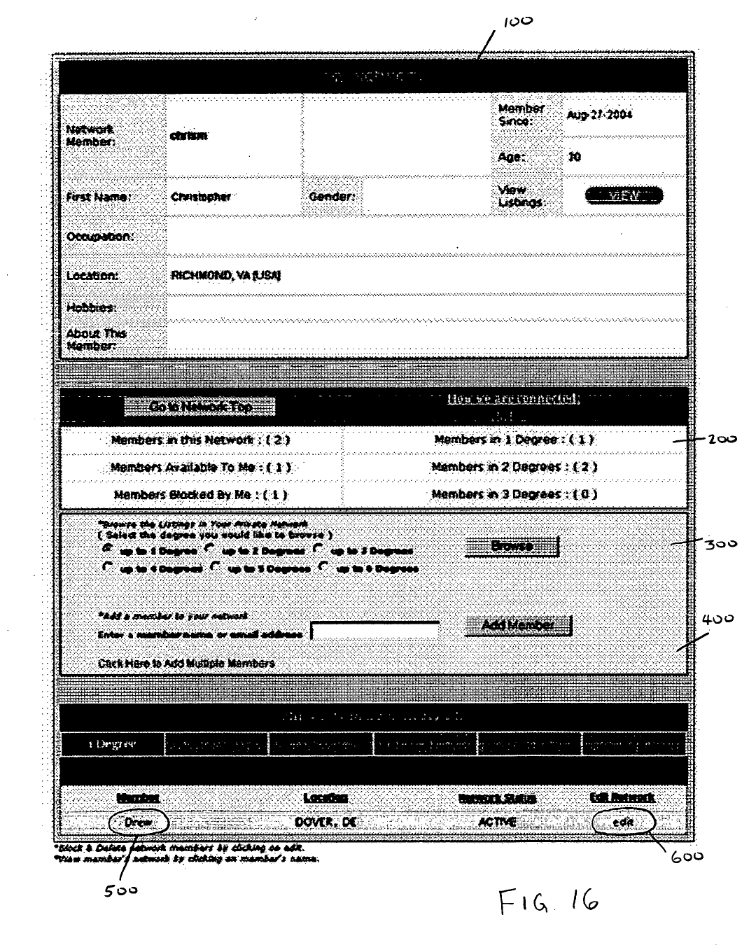

FIG. 16. details the interface component of user entity display contained in the user knowledge base of the authenticated user. [100] The interface contains accessible and non accessible data in regards to the primary user entity, whereby the data may contain descriptive data with regards to the primary user entity. [300] The interface will contain a section where the authenticated user can view all associated entities of other secondary user entities contained in their user knowledge base by selecting a level, in which that level determines the number of searches to be performed on the entity database using the unique user identifiers of the previous searches as a criteria, where as the initial search will always use the unique user identifier of the authenticated user as the criteria. [400] The interface will contain an input box where an authenticated user can enter a email address or a unique user identifier in the process of sending electronic messages to the recipient for the purposes of adding the recipient user entity to the said authenticated user knowledge base. [200] The interface will contain a section where user entities will be displayed resulting from the search of entity database using the authenticated unique user identifier as a criteria. [500] Each displayed user entity can then be further selected to display associated user entities of the said selected user entity through a search of the entity database using the unique user identifier of selected user entity as criteria. [600] The interface will also contain a associated edit link or uniform resource locator next to displayed user entities, when selected, will redirect the authenticated user to a new interface, in which that interface will allow the authenticated user to update flags located in each user entity for the purposing of restricting or allowing access to that entity or all associated entities of the said selected entity or remove the selected entity from the knowledge base of the authenticated user.

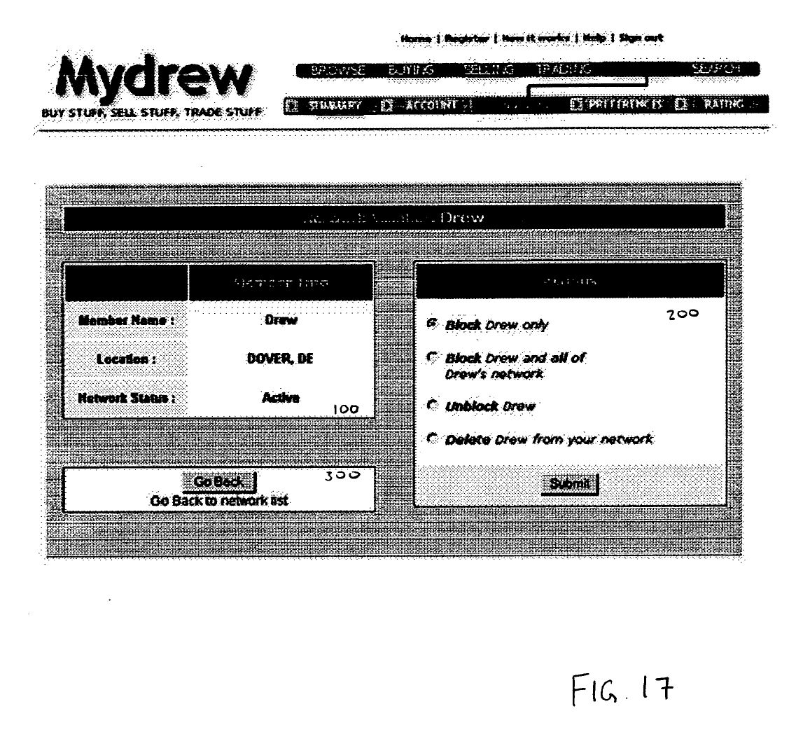

FIG. 17. details the interface component of restricting or allowing access to and from associated user entities with respect to the associated user entities of the authenticated user. [100] The interface will contain details about an individual user entity with the respect to an authenticated user entity. Details include the status of the user entity, current status flags of the user entity and the location data of the user entity. [200] The interface will contain selections for placing restrictions between the associated entities of the restricted user entity, restrictions on the associated entities of all user entities resulting in a search of the entity database using the unique user identifier of the said restricted entities, including the selected restricted entity, with respect to the authenticated user entity and any associated entities of the said authenticated user.

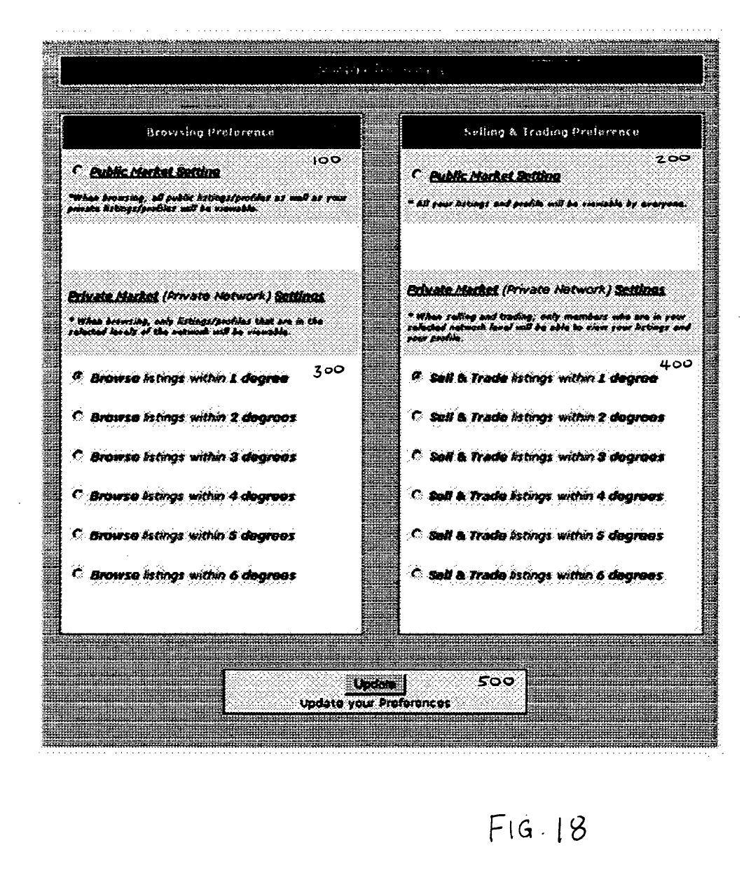

FIG. 18. details the interface component of user preference display in which an authenticated user can update the primary and secondary confidence level in the user entity and associated entities of their knowledge base. [300] The interface consists of seven distinct values to be selected for the primary confidence level and seven distinct values to be selected for the secondary confidence level, in which the values of both levels will contain the values of 0 through 6. [100] The primary confidence level of 0 shall represent that no restrictions will be applied in the access of entity data of other user entities with respect to the authenticated user. A primary confidence level of 1 through 6 shall represent the amount of access granted the authenticated user to the entity data of associated user entities where by the said user entities will be determined through search of the entity database, where the number of searches performed will not exceed the selected primary confidence level. [200] The secondary confidence level of 0 shall represent that no restrictions will be applied in the access of entity data of the authenticated user with respect to all other associated user entities. [400] A secondary confidence level of 1 through 6 shall represent the amount of access granted the entity data of the authenticated user with respect to any associated user entities included in the knowledge base of the said authenticated user, where by the access allowed the said associated user entities will be determined if the authenticated user is included in the generation of user knowledge base of the associated user entities, whereby result of searches to the entity database during generation of each associated entity knowledge base will include the authenticated user, where the number of searches performed to the entity database does not exceed the selected secondary confidence level of the authenticated user. All updated confidence levels will be associated with an authenticated user entity and saved to a central database.

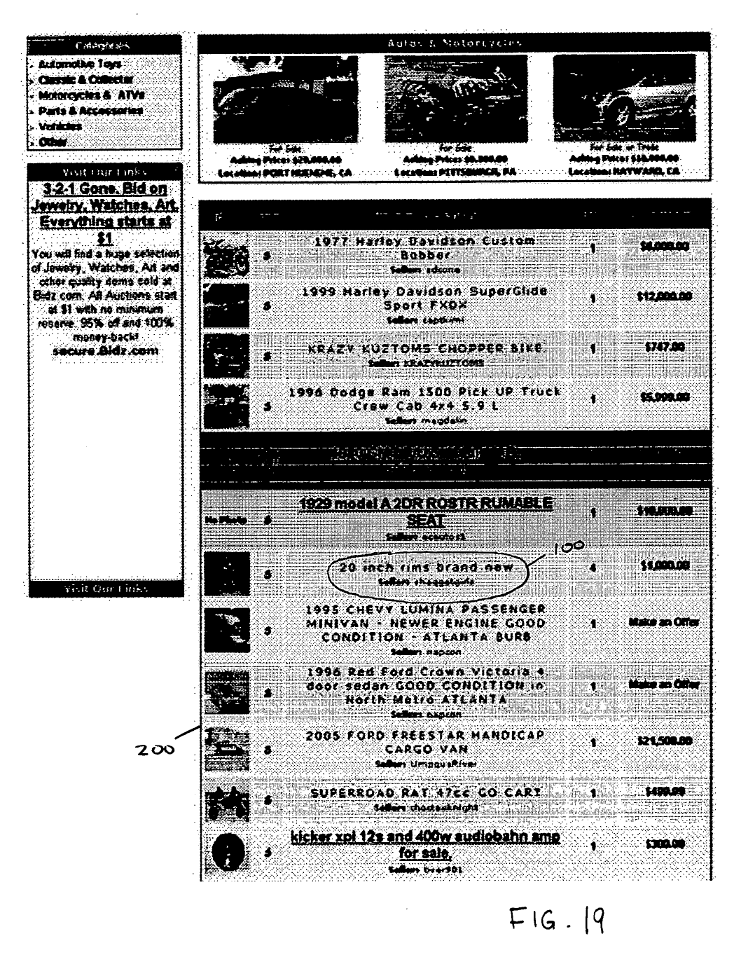

FIG. 19. details the interface component of displaying search results of associated user entities for a given authenticated user. [200] The interface component displays the result of an authenticated user searching a central database for associated entities with respect to unique user identifiers included in the authenticated user knowledge base. [100] The resulting search can be further processed for the purpose of creating a transaction between the authenticated user and the user entity associated with the search result.

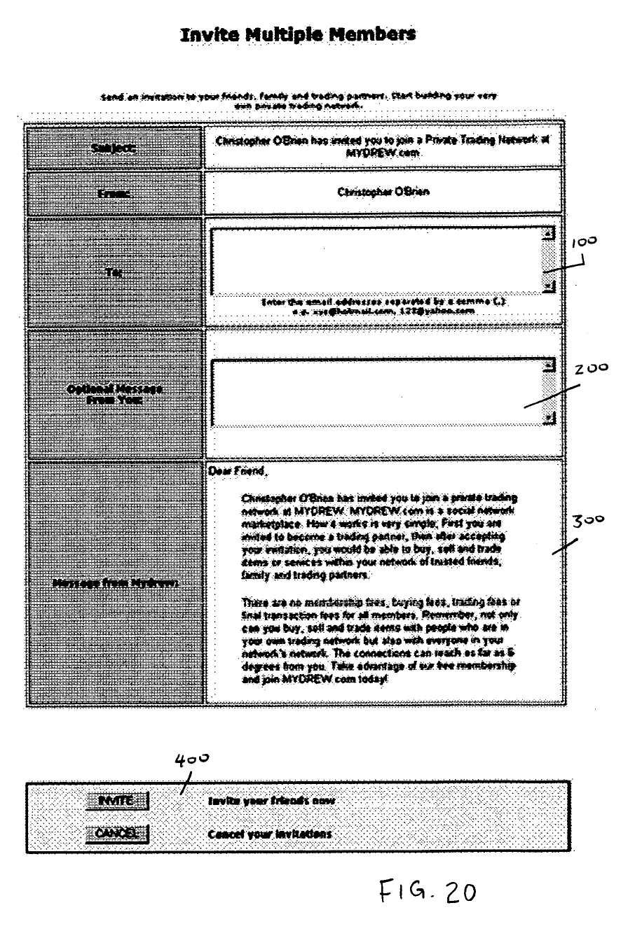

FIG. 20. details the interface component of sending electronic messages from an authenticated user to one or more recipients based on email addresses or unique user identifiers. [100] The interface component contains input fields where the authenticated user can enter one or more email addresses and unique user identifiers. [200] There contains an input field where the authenticated user can enter a text message in which such a message will be included in the [300] body of the electronic message sent to all recipients. [400] Once the form is completed, a search of the central database for each email address or unique user identifier will be performed. Electronic messages will be sent to all matched unique user identifier and to all email addresses, where by the sending method will use a SMTP mail server.

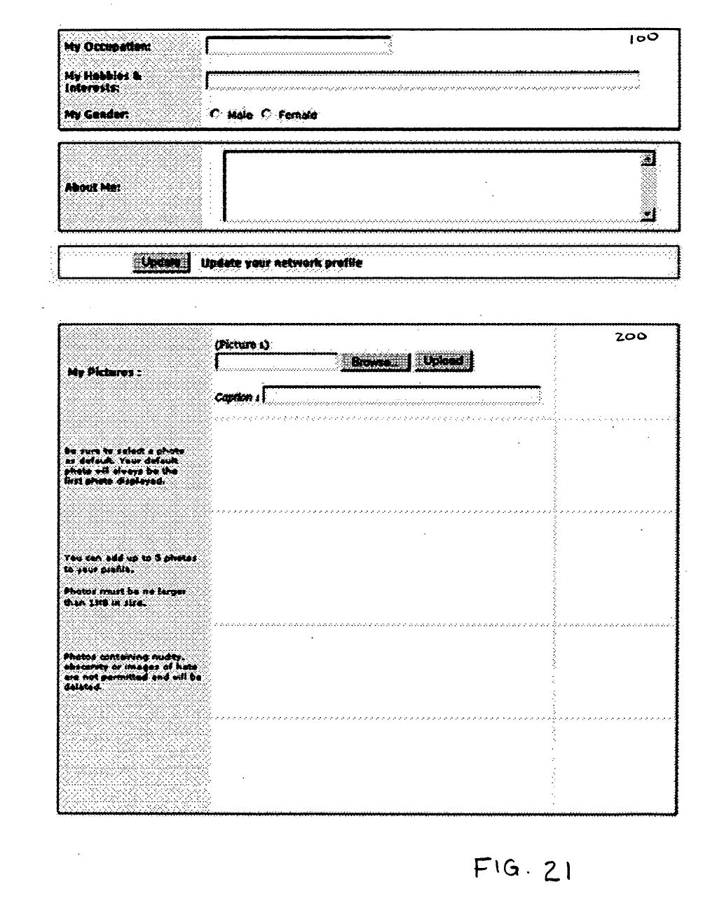

FIG. 21. details the interface component of creating and updating user entity data in which the data represents description of the said user entity. [100] The interface component contains fields describing the name, location, date of birth, occupation and images [200] of the said user entity. The data will have restricted or unrestricted access by other user entities depending on the primary or secondary confidence level of the said user entity, as well as primary and secondary confidence level of the user entity attempting access. Updates to the user entity data will be saved to a central database.

What is claimed:

1. A method of constructing an entity knowledge base consisting of data associated with a primary entity and one or more entities, the method including:
automatically assigning a confidence level to content within an electronic document associated with a primary entity, the content being potentially descriptive of the primary entity;
assigning a confidence level to electronic contents associated with an entity, whereby the confidence level determines the amount of access to the knowledge base of the said entity for other entities.
assigning a confidence level to an entity, whereby the confidence level determines the amount of access to the knowledge base of other entities for the said entity.
saving associated confidence levels to database
generating a knowledge base for an entity, whereby the knowledge base of direct and indirect associated entities are retrieved from a database

2. The method of claim 1 wherein descriptive content associated with an entity has unrestricted access, with respect to a second entity.

3. The method of claim 1 wherein descriptive content associated with an entity has restricted access, with respect to a second entity.

3. The method of claim 1 wherein electronic content associated with an entity has restricted access, with respect to a second entity.

4. The method of claim 1 wherein electronic content associated with an entity has unrestricted access, with respect to a second entity.

5. The method of claim 1 wherein electronic content associated with a second entity has restricted access, with respect to the first entity.

6. The method of claim 1, wherein electronic content associated with a second entity has unrestricted access, with respect to the first entity.

7. The method of claim 1, wherein the confidence levels associated with an entity is saved to a database.

8. The method of claim 1, wherein a primary entity retrieves from database select accessible data associated with one or more direct entities and stores such data in computer memory.

9. The method of claim 1, wherein a primary entity retrieves from database select accessible data associated with one or more indirect entities and stores such data in computer memory.

10. The method of displaying electronic documents associated with an entity user knowledge base for the said entity, the method including:
retrieve from database, direct and indirect associated entity knowledge
generate a knowledge base for an entity
retrieve electronic contents containing one or more content criteria from database
filter all electronic content retrieved from the database using selected data contained in the entity knowledge base of the said entity
display the result of content filtering through a web interface

11. The method of claim 10 wherein accessible data associated with one or more direct entities are retrieved from a database in order to create a knowledge base for a primary entity

12. The method of claim 10 wherein accessible data associated with one or more indirect entities are retrieved from a database and added to the knowledge base of a primary entity

13. The method of claim 10 wherein electronic contents containing one or more document criteria is retrieved from database

14. The method of claim 10 wherein retrieved electronic contents is filtered for display by the matching of accessible data located in the knowledge base of a primary entity.

15. The method of claim 10 wherein filtered electronic content is displayed through a web user interface.

16. The method of constructing a system for managing direct and indirect associated entities for display of entity related documents and facilitating entity related transactions in respect to a primary entity, the method including:
saving direct and indirect entity data in respect to primary entity data to database
removing direct and indirect entity data in respect to primary entity data from database
selecting a direct or indirect entity to place a block on in respect to a primary entity
selecting a block level for a primary entity and a blocked entity
saving the blocked entity data in respect to a primary entity to database
removing the blocked entity data in respect to a primary entity from database

17. The method of claim 16 where direct entity data and indirect entity data are saved to database. The saved data in respect to a primary entity, will create a connection for the said primary entity which can be retrieved and used at a later time.

18. The method of claim 16 where direct entity data and indirect entity data are removed from database. The removal of data in respect to the said primary entity, will delete the connection for the said entity and cannot be retrieved to be used at a later time.

19. The method of claim 16 where an entity or entities are selected for blocking with respect to a primary entity. Two types of block selection are available, the ability to block a single entity with respect to a primary entity and the ability to block a single entity and all direct and indirect entities of that blocked entity with respect to a primary entity.

20. The method of claim 16 where block data associated with a primary entity and one or more direct and indirect entities are saved to database to be retrieved at a later time.

21. The method of claim 16 where block data associated with a primary entity and one or more direct and indirect entities are removed from database, allowing access between the primary entity and one or more unblocked entities to exist.
